(19) United States
(12) Patent Application Publication
(10) Pub. No.: US 2003/0226310 A1
(43) Pub. Date: Dec. 11, 2003

(54) Minnow trapping apparatus

(76) Inventors: Clarence E. Rudder, Vancouver, WA (US); Kathleen C. Lindsley-Rudder, Vancouver, WA (US)

Correspondence Address: ANTHONY EDW. J CAMPBELL, PO BOX 160370, AUSTIN, TX, 78716, US

(21) Appl. No.: 10/164,940

(22) Filed: Jun. 6, 2002

(51) Int. Cl. A01K 69/00

(52) U.S. Cl. 43/100

(57) ABSTRACT

A minnow trapping apparatus that has an interlocking ring series having two opposite ends, a fishing line attachment end and a sinker end. A ribbon is attached to the interlocking ring series fishing line attachment end and the interlocking ring series sinker end.

### BACKGROUND OF THE INVENTION

1. Field of the Invention

The present invention relates to a minnow trapping apparatus for use in connection with fishing equipment. The minnow trapping apparatus has particular utility in connection with bait catching device.

2. Description of the Prior Art

Minnow trapping apparatuses are desirable for having fresh bait wherever a fisherman fishes without having to purchase minnows and keep them in an aerator or bait bucket as he transports them to the fishing destination. Additionally the fisherman would never run out of minnows while fishing in that he could use the minnow trapping apparatus to catch more minnows. A need was felt for a small, easily stored minnow trapping apparatus that could catch different sizes of minnows simultaneously.

The use of fishing equipment is known in the prior art. For example, U.S. Pat. No. 3,162,968 to Lorenzo discloses a bait catching rings apparatus that has a frame having an upper, lower, normally horizontal, rigid, vertically spaced spreader bars and a plurality of chains. Each chain comprises a single strand formed by a multiplicity of sequentially and directly interengaging oval-shaped open loop links. Each link is adapted to receive and ensnare a fish therein. First connector means attach the upper link of each chain in spaced relation to and along said upper bar. Second connector means attach the lower link of each chain in spaced relation to along said lower spreader bar. All the chains being held by the spacer bars in discrete spaced substantially parallel relation and means carried by the upper bar centrally thereof, to connect it to the fishing line. However, the Lorenzo '968 patent does not have an interlocking ring series forming an elongate body that has a central support element formed of a ribbon running the length of the rings and positioned outside of the rings for forming a minnow trapping apparatus.

Similarly, U.S. Pat. No. 5,157,864 to Kuroda et al discloses a crab trap apparatus that is formed with a torroidal ring mounting a plurality of snare loops at spaced intervals thereabout extending exteriorly of the ring. The invention includes bait securement structure medially thereof in the form of a bait mounting rod. However, the Kuroda et al '864 patent does not have an interlocking ring series forming an elongate body that has a central support element formed of a ribbon running the length of the rings and positioned outside of the rings for forming a minnow trapping apparatus.

Lastly, U.S. Pat. No. Des 411,813 to Visser discloses a jewelry chain that has a plurality of interlocking loops. However, the Visser '813 patent does not have an interlocking ring series forming an elongate body that has a central support element formed of a ribbon running the length of the rings and positioned outside of the rings for forming a minnow trapping apparatus.

While the above-described devices fulfill their respective, particular objectives and requirements, the aforementioned patents do not describe a minnow trapping apparatus that allows bait-catching device. The Lorenzo '968, Kuroda et al '864 and Visser '813 patents make no provision for an interlocking ring series forming an elongate body that has a central support element formed of a ribbon running the length of the rings and positioned outside of the rings for forming a minnow trapping apparatus.

Therefore, a need exists for a new and improved minnow trapping apparatus that can be used for bait catching device. In this regard, the present invention substantially fulfills this need.

In this respect, the minnow trapping apparatus according to the present invention substantially departs from the conventional concepts and designs of the prior art, and in doing so provides an apparatus primarily developed for the purpose of bait catching device.

### SUMMARY OF THE INVENTION

In view of the foregoing disadvantages inherent in the known types of fishing equipment now present in the prior art, the present invention provides an improved minnow trapping apparatus, and overcomes the above-mentioned disadvantages and drawbacks of the prior art. As such, the general purpose of the present invention, which will be described subsequently in greater detail, is to provide a new and improved minnow trapping apparatus and method which has all the advantages of the prior art mentioned heretofore and many novel features that result in a minnow trapping apparatus which is not anticipated, rendered obvious, suggested, or even implied by the prior art, either alone or in any combination thereof.

To attain this, the present invention essentially comprises an interlocking ring series having two opposite ends, a fishing line attachment end and a sinker end. A ribbon is attached to the interlocking ring series fishing line attachment end and the interlocking ring series sinker end.

There has thus been outlined, rather broadly, the more important features of the invention in order that the detailed description thereof that follows may be better understood and in order that the present contribution to the art may be better appreciated.

The invention may also include a fishing line swivel, a sinker swivel and a sinker weight. There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved minnow trapping apparatus that has all of the advantages of the prior art fishing equipment and none of the disadvantages.

It is another object of the present invention to provide a new and improved minnow trapping apparatus that may be easily and efficiently manufactured and marketed.

An even further object of the present invention is to provide a new and improved minnow trapping apparatus that has a low cost of manufacture with regard to both materials and labor, and which accordingly is then susceptible of low prices of sale to the consuming public, thereby making such minnow trapping apparatus economically available to the buying public.

Still another object of the present invention is to provide a new minnow trapping apparatus that provides in the apparatuses and methods of the prior art some of the advantages thereof, while simultaneously overcoming some of the disadvantages normally associated therewith.

Even still another object of the present invention is to provide a minnow trapping apparatus for catching live bait at the fishing site.

Lastly, it is an object of the present invention is to provide a minnow trapping apparatus that has swivels at both ends so it would not become tangled and have a weight at one end to keep the chain stretched out during use.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front side view of the preferred embodiment of the minnow trapping apparatus constructed in accordance with the principles of the present invention.

FIG. 2 is a front perspective view of the minnow trapping apparatus of the present invention.

FIG. 3 is a section view of the minnow trapping apparatus of the present invention.

The same reference numerals refer to the same parts throughout the various figures.

### DESCRIPTION OF THE PREFERRED EMBODIMENT

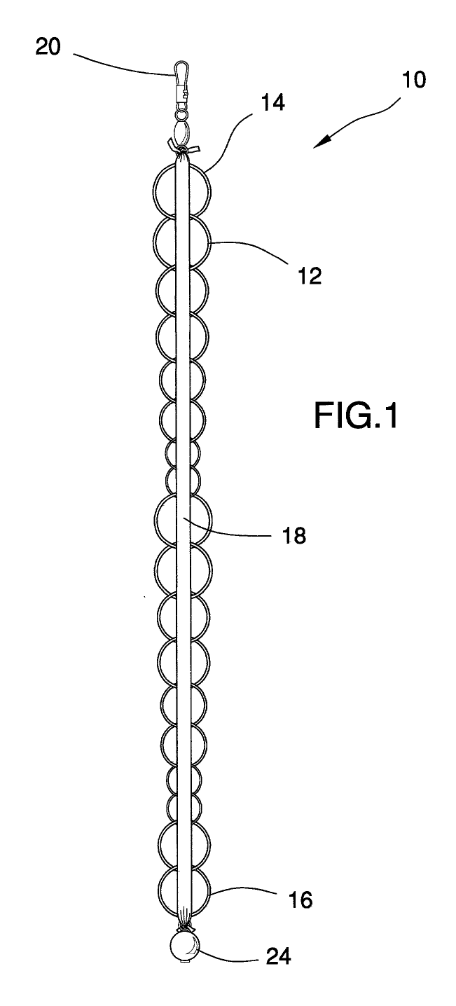

Referring now to the drawings, and particularly to FIGS. 1-3, a preferred embodiment of the minnow trapping apparatus of the present invention is shown and generally designated by the reference numeral 10.

In FIG. 1, a new and improved minnow trapping apparatus 10 of the present invention for bait catching device is illustrated and will be described. More particularly, the minnow trapping apparatus 10 has an interlocking ring series 12 having two opposite ends, a fishing line attachment end 14 and a sinker end 16. A ribbon 18 is attached to the interlocking ring series fishing line attachment end 14 and the interlocking ring series sinker end 16. The ribbon 18 is disposed alongside the interlocking ring series 12. The ribbon 18 attached length is of approximately the same length as the interlocking ring series length. The ribbon 18 is approximately one quarter of an inch in width. The ribbon 18 is red. A fishing line swivel 20 is attached to the interlocking ring series fishing line attachment end 14. A sinker weight 24 is attached to the interlocking ring series sinker end 16. A sinker swivel 22 forms the attachment between the sinker weight 24 and the interlocking ring series sinker end 16. The interlocking rings 12 are rigid. The interlocking rings 12 are comprised of non-rusting metal. The interlocking rings 12 have diameters of approximately ½, ¾, 1 and 1⅛ inches. The interlocking ring series 12 length is between 12 inches and 18 inches.

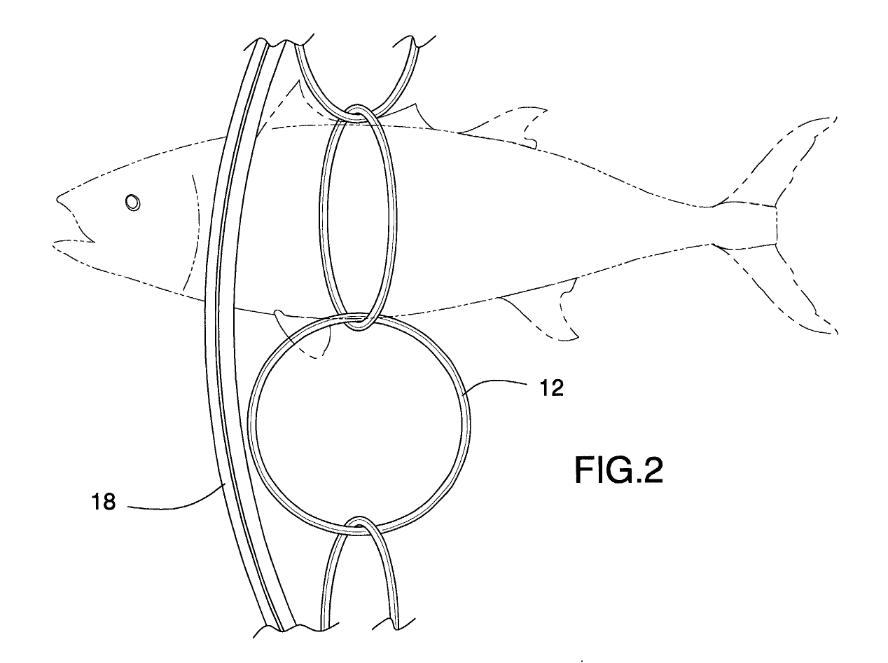

In FIG. 2, the minnow trapping apparatus 10 is illustrated and will be described. The minnow trapping apparatus 10 has the interlocking ring series 12. The ribbon 18 is disposed alongside the interlocking ring series 12. The interlocking rings 12 have diameters of approximately ½to 1⅛ inches. The ribbon 18 attached length is of approximately the same length as the interlocking ring series length. The ribbon 18 is approximately one quarter of an inch in width. The ribbon 18 is red. The interlocking rings 12 are rigid. The interlocking rings 12 are comprised of non-rusting metal.

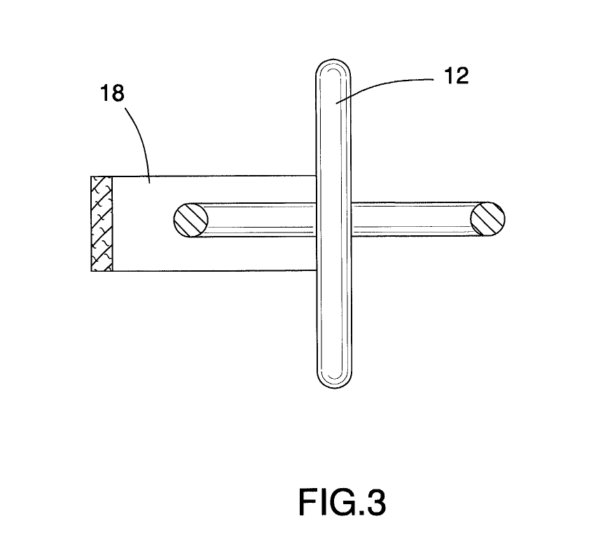

In FIG. 3, the minnow trapping apparatus 10 is illustrated and will be described. The minnow trapping apparatus 10 has the interlocking ring series 12. The ribbon 18 is disposed alongside the interlocking ring series 12. The ribbon 18 is approximately one quarter of an inch in width. The interlocking rings 12 are rigid and comprised of non-rusting metal.

In use it can now be seen that before starting to fish the fisherman would simply connect the minnow trapping apparatus 10 to his line and lower it into the water. Minnows and other baitfish would attempt to swim through the rings and would become trapped. After a few minutes, the fisherman would retrieve the tester and see which rings caught minnows. This would tell the fisherman the size of bait in the area so that he could attach the appropriately sized minnow trapping apparatus 10 to his line and repeat the process to catch more minnows.

While a preferred embodiment of the minnow trapping apparatus has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable sturdy material such as plastic, or brass may be used instead of the stainless steel described. Also, the ribbon may be made of a color other than red. And although bait catching device have been described, it should be appreciated that the minnow trapping apparatus herein described is also suitable for capturing any small aquatic creature.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A minnow trapping apparatus comprising:
an interlocking ring series having two opposite ends, a fishing line attachment end and a sinker end; and
a ribbon attached to said interlocking ring series fishing line attachment end, said ribbon attached to said interlocking ring series sinker end.

2. The minnow trapping apparatus of claim 1 further comprising:
a fishing line swivel attached to said interlocking ring series fishing line attachment end.

3. The minnow trapping apparatus of claim 1 further comprising:
a sinker weight attached to said interlocking ring series sinker end.

4. The minnow trapping apparatus of claim 3 further comprising:
a sinker swivel forming said attachment between said sinker weight and said interlocking ring series sinker end.

5. The minnow trapping apparatus of claim 1 wherein:
said ribbon is disposed alongside said interlocking ring series.

6. The minnow trapping apparatus of claim 1 wherein:
said ribbon attached length is of approximately the same length as said interlocking ring series length.

7. The minnow trapping apparatus of claim 1 wherein:
said ribbon is approximately one quarter inch in width.

8. The minnow trapping apparatus of claim 1 wherein:
said ribbon is red.

9. The minnow trapping apparatus of claim 1 wherein:
said interlocking rings are rigid.

10. The minnow trapping apparatus of claim 1 wherein:
said interlocking rings are comprised of non-rusting metal.

11. The minnow trapping apparatus of claim 1 wherein:
said interlocking rings have diameters of approximately ½ inch to 1⅛ inches.

12. The minnow trapping apparatus of claim 1 wherein:
said interlocking ring series length is between 12 inches and 18 inches.

13. A minnow trapping apparatus comprising:
an interlocking ring series having two opposite ends, a fishing line attachment end and a sinker end;
a ribbon attached to said interlocking ring series fishing line attachment end and said interlocking ring series sinker end; and
a fishing line swivel attached to said interlocking ring series fishing line attachment end.

14. The minnow trapping apparatus of claim 13 further comprising:
a sinker weight attached to said interlocking ring series sinker end.

15. The minnow trapping apparatus of claim 14 farther comprising:
a sinker swivel forming said attachment between said sinker weight and said interlocking ring series sinker end.

16. The minnow trapping apparatus of claim 13 wherein:
said ribbon disposed alongside said interlocking ring series, said ribbon attached length is of approximately the same length as said interlocking ring series length, said ribbon is approximately one quarter inch in width, said ribbon is red.

17. The minnow trapping apparatus of claim 13 wherein:
said interlocking rings are comprised of non-rusting metal.

18. The minnow trapping apparatus of claim 13 wherein:
said interlocking rings have diameters of approximately ½ inch to 1⅛ inches; and
said interlocking ring series length is between 12 inches and 18 inches.

19. A minnow trapping apparatus comprising:
an interlocking ring series having two opposite ends, a fishing line attachment end and a sinker end;
a ribbon attached to said interlocking ring series fishing line attachment end and said interlocking ring series sinker end, said ribbon is disposed alongside said interlocking ring series, said ribbon attached length is of approximately the same length as said interlocking ring series length, said ribbon is approximately one quarter inch in width, said ribbon is red;
a fishing line swivel attached to said interlocking ring series fishing line attachment end; and
a sinker weight attached to said interlocking ring series sinker end.

20. The minnow trapping apparatus of claim 18 further comprising:
a sinker swivel forming said attachment between said sinker weight and said interlocking ring series sinker end.
